(19) United States
(12) Patent Application Publication
(10) Pub. No.: US 2011/0286390 A1
(43) Pub. Date: Nov. 24, 2011

(54) WIRELESS IMAGE TRANSMITTING APPARATUS AND METHOD FOR TRANSMITTING DATA THEREOF

(76) Inventors: Jiun-Ying JOU, Taipei City (TW); Tung-Yang Lee, Taipei City (TW); Wei-Ching Lin, Taipei City (TW); Che-Hao Cheng, Taipei City (TW); Sheng-Feng Lin, Taipei City (TW); Kong-Ling Hsieh, Taipei City (TW); Yen-Lin Kuo, Taipei City (TW); Shih-Hung Liu, Taipei City (TW); Cheng-Ching Chen, Taipei City (TW); Chih-Hsin Chuang, Taipei City (TW); Ching-Chun Liao, Taipei City (TW)

(21) Appl. No.: 13/110,678

(22) Filed: May 18, 2011

(30) Foreign Application Priority Data
May 19, 2010 (TW) 099115964

(51) Int. Cl. H04W 4/00

(52) U.S. Cl. 370/328

(57) ABSTRACT

A wireless image transmitting apparatus includes an image processing unit, a wireless bridging module, and a wireless local area network module. The wireless bridging module includes a network switch and a network port. The network switch is in signal communication with the network port and the image processing unit. The WLAN module is in signal communication with the network switch. The WLAN module uses a first type of packet and a first band to transmit a signal from the image processing unit and uses a second type of packet and a second band to transmit a signal from the network port. A method for transmitting data in a wireless image transmitting apparatus is also disclosed.

### CROSS REFERENCE TO RELATED APPLICATIONS

This Non-provisional application claims priority under 35,U.S.C. §119(a) on Patent Application No(s). 099115964 filed in Taiwan, Republic of China on May 19, 2010, the entire contents of which are hereby incorporated by reference.

### BACKGROUND OF THE INVENTION

1. Field of Invention

This invention relates to an image transmitting apparatus and a method for transmitting data thereof and, more particularly, to a wireless image transmitting apparatus and a method for transmitting data thereof.

2. Related Art

Conventionally, multimedia products output images to displays via video signal wires or a wireless network. FIG. 1 is a schematic diagram of a conventional wireless image transmitting apparatus. In FIG. 1, a media playing apparatus 13 outputs media data to a wireless transmitting apparatus 11 via a video signal wire, and the wireless transmitting apparatus 11 transmits the received media data to a wireless receiving apparatus 12 via a wireless network. The wireless receiving apparatus 12 determines an outputting format of the media data according to a mode of connecting a media presenting apparatus 14 after receiving the media data from the wireless network. For example, the wireless receiving apparatus 12 transmits the media data to a display for display via a high definition multimedia interface (HDMI) signal wire or an S-video signal wire.

Conventionally, neither a wireless transmitting apparatus nor a wireless receiving apparatus for transmitting video integrates functions of network switching, bridging, or routing. Instead, they only perform a peer-to-peer transmission of media data via the wireless network. If users want to build a wireless local area network (WLAN) for computers or personal digital assistants, they still have to need a wireless broadband share or router.

### SUMMARY OF THE INVENTION

One embodiment of this invention provides a wireless image transmitting apparatus and a method for transmitting data thereof, being capable of simultaneously transmitting network data and transmitting image data to an image displaying apparatus for display.

To achieve the above, a wireless image transmitting apparatus according to the invention includes an image processing unit, a wireless bridging module, and a WLAN module. The wireless bridging module includes a network switch and a network port. The network switch is in signal communication with the network port and the image processing unit. The WLAN module is in signal communication with the network switch. The WLAN module uses a first type of packet and a first band to transmit a signal from the image processing unit and uses a second type of packet and a second band to transmit a signal from the network port.

In one embodiment, the image processing unit is electrically connected with a media playing apparatus via a signal wire.

In one embodiment, the WLAN module transmits the fist type of packet and the second type of packet to a WLAN.

In one embodiment, the signal from the network port comes from a terminal apparatus or an external network, and the signal from the image processing unit comes from a media playing apparatus.

In one embodiment, the WLAN module operates following Wi-Fi standard. The first band is defined by IEEE 802.11a, and the second band is defined by IEEE 802.11g.

In one embodiment, the first type of packet and the second type of packet is user datagram protocol (UDP) packet and transmission control protocol (TCP) packet, respectively.

In one embodiment, the wireless image transmitting apparatus includes a peripheral interface module electrically connected with the image processing unit and further connected with an external peripheral apparatus.

In one embodiment, a simulation connection is established between a terminal apparatus of a WLAN and the external peripheral apparatus, allowing the terminal apparatus to recognize the external peripheral apparatus as an apparatus of a peripheral interface specification.

A method for transmitting data in a wireless image transmitting apparatus according to the invention includes the following steps. A signal from an image processing unit and a signal from a network port are received. A first type of packet and a first band are used to transmit the signal from the image processing unit via a wireless local area network. A second type of packet and a second band are used to transmit the signal from the network port via the wireless local area network.

In one embodiment, the signal from the network port comes from a terminal apparatus or an external network, and the signal from the image processing unit comes from a media playing apparatus.

In one embodiment, the first band is defined by IEEE 802.11a, and the second band may be defined by IEEE 802.11g.

In one embodiment, the first type of packet and the second type of packet is UDP packet and TCP packet, respectively.

In one embodiment, the signal from the image processing unit is transmitted to a media presenting apparatus via the wireless local area network, and the signal from the network port may be transmitted to a terminal apparatus via the wireless local area network.

In one embodiment, the method includes the step of connecting an external peripheral apparatus following a peripheral interface specification.

In one embodiment, the method may further include the step of establishing a simulation connection between a terminal apparatus of the WLAN and the external peripheral apparatus, allowing the terminal apparatus to recognize the external peripheral apparatus as an apparatus of the peripheral interface specification.

To sum up, in the wireless image transmitting apparatus according to the invention, network data can be transmitted via the connection between the network port and the external network, and the media data can be transmitted to the media presenting apparatus via the WLAN module. Compared with the prior art, the invention provides an apparatus and a method thereof for wireless image transmission and accessing Internet wirelessly.

These and other features, aspects, and advantages of the present invention will become better understood with regard to the following description, appended claims, and accompanying drawings.

### BRIEF DESCRIPTION OF THE DRAWINGS

FIG. 1 is a schematic diagram of a conventional wireless image transmitting apparatus;

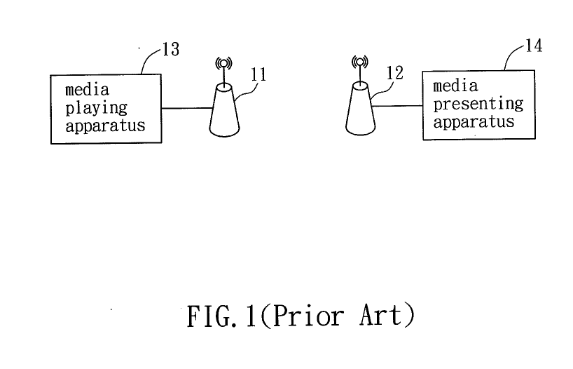

FIG. 2 is a schematic diagram of a wireless image transmitting apparatus according to one preferred embodiment; and

FIG. 3 is a flow chart showing a method for transmitting data in a wireless image transmitting apparatus according to one preferred embodiment.

### DETAILED DESCRIPTION OF THE INVENTION

A wireless image transmitting apparatus according to preferred embodiments is described cooperating with the related drawings hereinbelow, and the same elements use the same reference numbers.

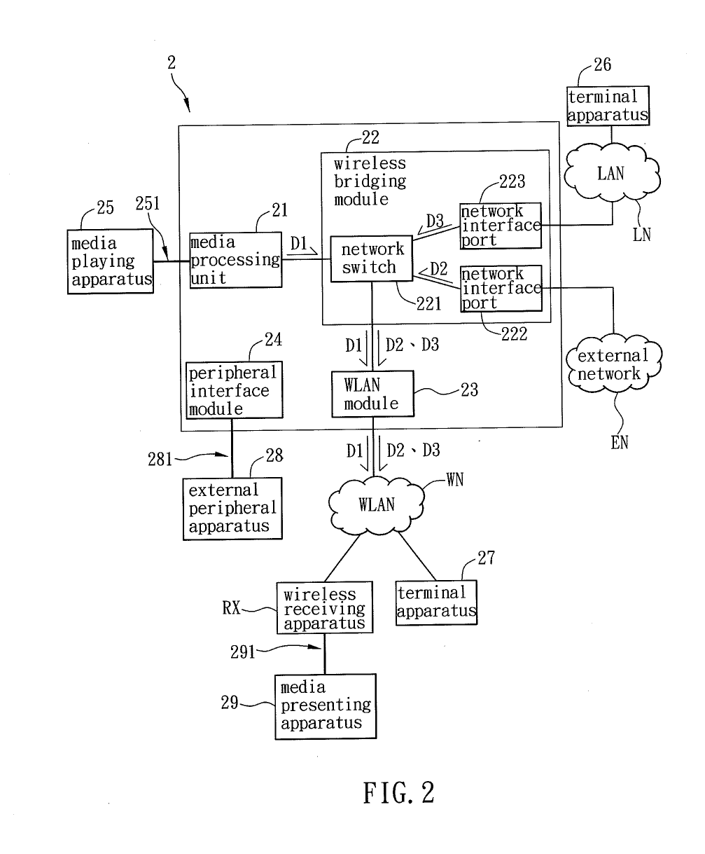

FIG. 2 is a schematic diagram of a wireless image transmitting apparatus according to one preferred embodiment. In FIG. 2, the wireless image transmitting apparatus 2 includes an image processing unit 21, a wireless bridging module 22, and a WLAN module 23. The wireless bridging module 22 includes a network switch 221 and at least one network port. In this embodiment, the wireless bridging module 22 includes a plurality of network ports 222, 223. The network switch 221 is in signal communication with the network ports 222, 223 and the image processing unit 21, and the WLAN module 23 is in signal communication with the network switch 221. The WLAN module 23 uses a first type of packet and a first band to transmit a signal D1 from the image processing unit 21 and uses a second type of packet and a second band to transmit a signal D2 from the network port 222. In the embodiment, the signal D1 from the image processing unit comes from a media playing apparatus 25, and the signal D2 from the network port comes from an external network EN.

The image processing unit 21 is electrically connected with the media playing apparatus 25 via a signal wire 251. The common media playing apparatus 25 may be a DVD player. The media playing apparatus 25 outputs media data including image and sound, and it transmits the media data to the image processing unit 21 via the signal wire 251. The image processing unit 21 transmits the media data to the WLAN module 23 via the network switch 221 after processing the media data.

The external network EN transmits network data to the network port 222 which is connected with the network switch 221, and then the network data is transmitted to the WLAN module 23 via the network switch 221.

The WLAN module 23 is in signal communication with the network switch 221 which receives the signal D1 from the image processing unit 21 and the signal D2 from the network port 222. The WLAN module 23 uses the first type of packet and the first band to transmit the signal D1 from the image processing unit 21 and uses the second type of packet and the second band to transmit the signal D2 from the network port 222. Further, the network switch 221 simultaneously transmits the signal D1 from the image processing unit via the first band and transmits the signal D2 from the network port via the second band to a WLAN WN.

The WLAN module 23 operates following Wi-Fi standard. The first band is defined by IEEE 802.11a, and the second band is defined by IEEE 802.11g. The first type of packet and the second type of packet are UDP packet and TCP packet, respectively. Thus, the signal D1 from the image processing unit and the signal D2 from the network port may not interfere with each other, and transmission rate and stability of the network are improved.

Further, a signal D3 from the network port come from a terminal apparatus 26 of a local area network (LAN) LN. The common terminal apparatus 26 may be an apparatus with an operating system such as a computer or a personal digital assistant. The terminal apparatus 26 is in signal communication with the network port 223 via the LAN LN, and the terminal apparatus 26 can receive the network data from the external network EN via the network switch 221, thus providing the function of accessing Internet for users. Further, the signal D3 from the network port coming from the terminal apparatus is transmitted to the WLAN module 23 via the network switch 221.

A wireless receiving apparatus RX communicates with another terminal apparatus 27 via the WLAN WN. The wireless receiving apparatus RX receives the signal D1 from the image processing unit via the WLAN WN. Further, the wireless receiving apparatus RX decodes the signal D1 from the image processing unit into media data and transmits the signal D1 from the image processing unit to a media presenting apparatus 29 via another signal wire 291. The media presenting apparatus 29 is an apparatus which can simultaneously present image and sound, such as a television or a monitor with a loudspeaker. In addition, the media presenting apparatus 29 may also be a combination of a display and an audio apparatus, such a combination of a monitor only for display and a loudspeaker, or a combination of a projector and a loudspeaker. The signal wire 291 is an HDMI signal wire or an S-video signal wire, which can simultaneously output image and sound to the media presenting apparatus 29. Thus, the media playing apparatus 25 transmits the media data to the media presenting apparatus 29 for play via the wireless image transmitting apparatus 2 and the WLAN WN to achieve the function of transmitting media data via the wireless local area network.

Further, the WLAN WN is in signal communication with another terminal apparatus 27, and it can receive the network data from the external network EN. Naturally, the terminal apparatus 27 also receives data from the terminal apparatus 26 via the WLAN WN.

The wireless image transmitting apparatus 2 has the functions of network switching, bridging, or routing and so on. The terminal apparatus 26 of the LAN LN and the terminal apparatus 27 of the WLAN WN are connected to the external network EN via the wireless image transmitting apparatus 2 to achieve the function of accessing Internet.

Besides the functions of wireless image transmission and accessing Internet wirelessly, the wireless image transmitting apparatus 2 also includes a peripheral interface module 24 electrically connected with the image processing unit 21 and connected with an external peripheral apparatus 28. The external peripheral apparatus 28 may be a mouse, a keyboard, or a non-volatile memory. The non-volatile memory may be a flash memory, a flash drive, or a hard disk drive.

A simulation connection 281 is established between the terminal apparatus 27 and the external peripheral apparatus 28 via the WLAN WN, allowing the terminal apparatus 27 to recognize the external peripheral apparatus 28 as an apparatus of a peripheral interface specification. For example, the external peripheral apparatus 28 is a USB memory such as a USB flash drive, and the peripheral interface module 24 conforms to USB interface specification. Thus the terminal apparatus 27 establishes a USB connection via the WLAN. When the external peripheral apparatus 28 is connected with the peripheral interface module 24, the simulation connection 281 is established between the terminal apparatus 27 and the external peripheral apparatus 28. Further, the terminal apparatus 27 recognizes the external peripheral apparatus 28 as the apparatus of the USB interface specification. In a word, the terminal apparatus 27 regards the external peripheral apparatus 28 as the apparatus directly connected with the terminal apparatus 27, and the terminal apparatus 27 and the external peripheral apparatus 28 transmit data with each other via the WLAN WN and the wireless image transmitting apparatus 2. The terminal apparatus 26 connected with the network port 223 also establishes the simulation connection 281 to be connected with the external peripheral apparatus 28 via the peripheral interface module 24.

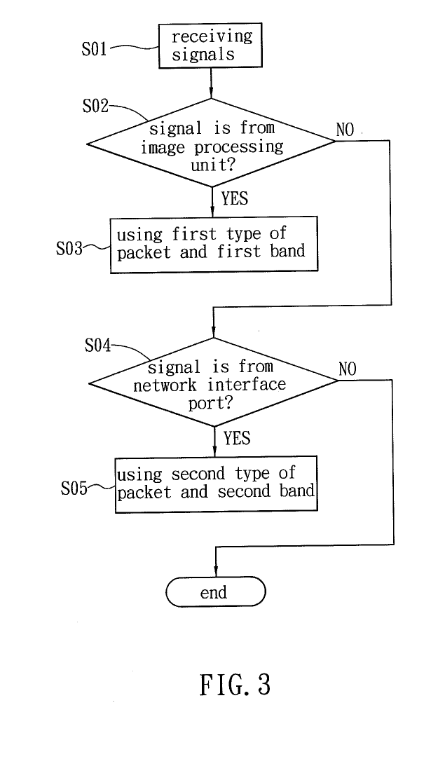

FIG. 3 is a flow chart showing a method for transmitting data in a wireless image transmitting apparatus according to one preferred embodiment. In FIG. 3, the method includes steps S01˜S05.

First, step S01 includes the step of receiving a signal from an image processing unit and a signal from a network port. In step S02, It is to determine whether the signal is from the image processing unit. In step S03, if the signal is from the image processing unit, a first type of packet and a first band are used to transmit the signal from the image processing unit via a wireless local area network. In step S04, It is to determine whether the signal is from the network port. In step S05, if the signal is from the network interface port, a second type of packet and a second band are used to transmit the signal from the network interface port via the wireless local area network.

That is, in the method, media data and network data are received from a media playing apparatus and an external network, respectively, and then the media data and the network data are transmitted to a media presenting apparatus and a terminal apparatus via the WLAN using different bands, respectively.

Further, the method for transmitting data includes the step of connecting an external peripheral apparatus following a peripheral interface specification. That is, a simulation connection is established between the terminal apparatus of the WLAN and the external peripheral apparatus, allowing the terminal apparatus to recognize the external peripheral apparatus as an apparatus of the peripheral interface specification.

In the aforementioned embodiments, the wireless image transmitting apparatus has the functions of wireless image transmission and network bridging or sharing, and therefore the users can simultaneously transmit the media data and the network data via the WLAN and the external network, thus preventing bandwidth of transmitting the media data and bandwidth of transmitting the network data from interfering with each other. Further, different terminal apparatus can exchange or share data via the LAN or the WLAN. Since the simulation connection is established via the WLAN, the peripheral interface apparatus is remotely controlled by the terminal apparatus.

To sum up, in the wireless image transmitting apparatus according to the preferred embodiments of the invention, the network data is transmitted to the terminal apparatus which is in signal communication with the network port or to the terminal apparatus which is in signal communication with the WLAN via the connection between the wireless bridging module and the external network. The media data is transmitted to the media presenting apparatus via the wireless bridging module and the WLAN module.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A wireless image transmitting apparatus comprising:
an image processing unit;
a wireless bridging module including a network switch and a network port, the network switch being in signal communication with the network port and the image processing unit; and
a wireless local area network module in signal communication with the network switch, wherein the wireless local area network module uses a fist type of packet and a fist band to transmit a signal from the image processing unit and uses a second type of packet and a second band to transmit a signal from the network port.

2. The wireless image transmitting apparatus according to claim 1, wherein the image processing unit is electrically connected with a media playing apparatus via a signal wire.

3. The wireless image transmitting apparatus according to claim 1, wherein the wireless local area network module transmits the fist type of packet and the second type of packet to a wireless local area network.

4. The wireless image transmitting apparatus according to claim 1, wherein the signal from the network port comes from a terminal apparatus or an external network, and the signal from the image processing unit comes from a media playing apparatus.

5. The wireless image transmitting apparatus according to claim 1, wherein the wireless local area network module operates following Wi-Fi standard, the first band is defined by IEEE 802.11a, and the second band is defined by IEEE 802.11g.

6. The wireless image transmitting apparatus according to claim 1, wherein the first type of packet and the second type of packet are user datagram protocol packet and transmission control protocol packet, respectively.

7. The wireless image transmitting apparatus according to claim 1, further comprising:
a peripheral interface module electrically connected with the image processing unit and further connected with an external peripheral apparatus.

8. The wireless image transmitting apparatus according to claim 7, a simulation connection being established between a terminal apparatus of a wireless local area network and the external peripheral apparatus, allowing the terminal apparatus to recognize the external peripheral apparatus as an apparatus of a peripheral interface specification.

9. A method for transmitting data in a wireless image transmitting apparatus comprising steps of:
receiving a signal from an image processing unit and a signal from a network port;
using a first type of packet and a first band to transmit the signal from the image processing unit via a wireless local area network; and
using a second type of packet and a second band to transmit the signal from the network port via the wireless local area network.

10. The method according to claim 9, wherein the signal from the network port comes from a terminal apparatus or an external network, and the signal from the image processing unit comes from a media playing apparatus.

11. The method according to claim 9, wherein the first band is defined by IEEE 802.11a, and the second band is defined by IEEE 802.11g.

12. The method according to claim 9, wherein the first type of packet and the second type of packet are UDP packet and TCP packet, respectively.

13. The method according to claim 9, wherein the signal from the image processing unit is transmitted to a media presenting apparatus via the wireless local area network, and the signal from the network port is transmitted to a terminal apparatus via the wireless local area network.

14. The method according to claim 9, further comprising the step of:
connecting an external peripheral apparatus following a peripheral interface specification.

15. The method according to claim 14, further comprising the step of:
establishing a simulation connection between a terminal apparatus of the wireless local area network and the external peripheral apparatus, allowing the terminal apparatus to recognize the external peripheral apparatus as an apparatus of the peripheral interface specification.
